(19) United States
(12) Patent Application Publication
(10) Pub. No.: US 2014/0208534 A1
(43) Pub. Date: Jul. 31, 2014

(54) Round 2 and Pocket Round

(71) Applicant: Galen B. Merrell, Sandy, UT (US)

(72) Inventor: Galen B. Merrell, Sandy, UT (US)

(21) Appl. No.: 13/751,596

(22) Filed: Jan. 28, 2013

(51) Int. Cl. B60S 3/04

(52) U.S. Cl. CPC B60S 3/045
USPC 15/236.02

(57) ABSTRACT

Two, cone shaped windshield ice scrapers attached and operated as a single unit yet designed to be separated, each capable of scraping independently. These scrapers have a new and improved scraping surface and nesting attribute to be sold with the existing popular “Scrape-A-Round”, thereby comprising the complete winter time window care system. These scrapers adopt most of the attributes of the “Scrape-A-Round” including method of operation, and of injection molded plastic construction and etc.

### BACKGROUND

1. Field of Invention

This invention relates to the cleaning and scraping of ice, snow and frost from the windshields and side and rear windows of automobiles and trucks and doing it cleaner and more rapidly than traditional scrapers.

2. Description of Prior Art

The invention “Scrape-A-Round”, U.S. Pat. No. 5,806,134 is owned by Galen Merrell, the same inventor as this patent applicant. The Round 2 and Pocket Round are two new items which came about as improvements to the “Scrape-A-Round” based on customer comments requesting a complete ice scraping package. The Round 2 and Pocket Round will be sold with the “Scrape-A-Round” in a (4) piece set nested together and packaged as the complete winter time window care system. The Round 2 and Pocket Round will have most of the “Scrape-A-Round” attributes and shape and manner of operation but will have an improved scraping surface and threaded interface option as well as a domed handle (neck) feature on the Pocket Round.

The Round 2 and Pocket Round have a Provisional Patent status, applied on Jul. 13, 2012 with a confirmation receipt dated Jul. 31, 2012 with U.S. application No. 61/741,225

Round 2 is a cone shaped windshield ice scraper open at the top and bottom ends, the bottom end is called the base and is larger than the top end. The base is encircled with a stiffener and a scraping surface composed of the intersection of a vertical surface facing outward and a sloped surface facing inward which is the continuation of the interior cone slope. The top end of the cone is intersected with a cylinder neck that is open at both ends. The cylinder is sized to receive the domed handle (or neck) of the Pocket Round.

The Pocket Round is a smaller version of the Round 2 with the same cone shape and scraping surface and is sized to be carried in a coat pocket. The cylinder handle (or neck) varies from the Round 2, in that the top of the neck is domed instead of open and is sized to fit in the neck of the Round 2. The two units are to be press fitted together and operate as a single unit until such time as the owner wishes to separate them to carry the smaller Pocket Round with him for convenience in his coat pocket. Both scrapers are made of injection molded plastic.

Operation of the combined units is to grasp the cone section of the larger Round 2 and place it's scraping surface (base) against the frosted window and with circular motion scrape the ice away, for smaller areas, turn the combined unit over and repeat the motion with the smaller scraping surface of the Pocket Round against the frosted window.

A description and drawings of the Round 2 and Pocket Round are further defined as follows. A typical embodiment of the present invention in Drawing 1/4 showing the nature of the cone shaped “Round 2” and in Drawing 2/4 showing the nature of the domed “Pocket Round” and in Drawing 3/4 showing the nature of “Round 2” and “Pocket Round” assembled and in Drawing 4/4 showing the nature of the new and improved scraping surface featuring the vertical outward facing surface (5) intersected by a sloped inward facing cone surface (6). This beveled feature forms a ring traversing the perimeter of the base.

### DRAWING FIGURES

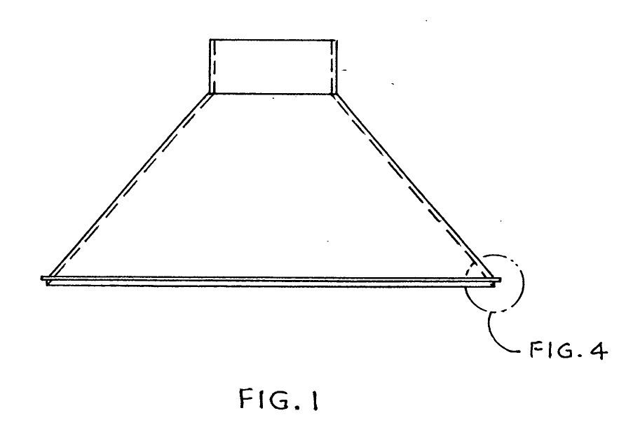

Drawing 1/4 Shows FIG. 1 “Round 2” in elevation.

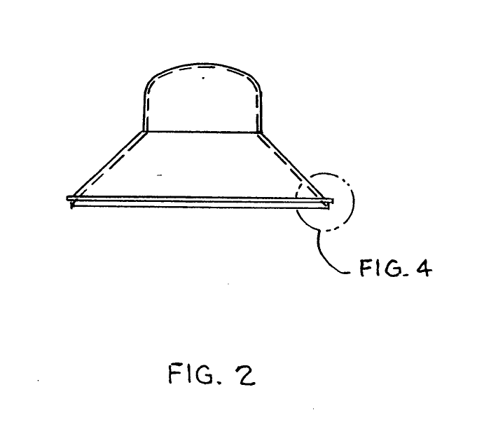

Drawing 2/4 Shows FIG. 2 “Pocket Round” in elevation.

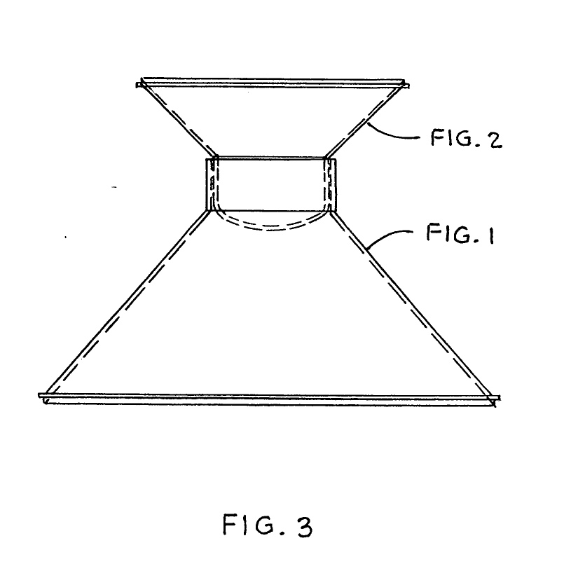

Drawing 3/4 Shows FIG. 3 “Round 2” and “Pocket Round” assembled.

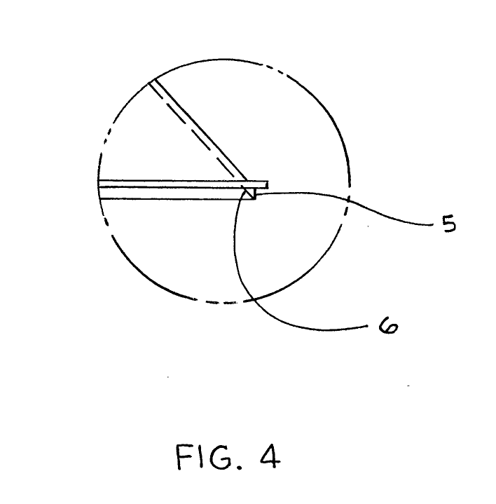

Drawing 4/4 Shows FIG. 4 new and improved scraping surface detail.

### REFERENCE NUMBERS IN DRAWINGS

FIG. 1 “Round 2” FIG. 2 “Pocket Round” FIG. 3 Assembled

FIG. 4 Reference to new and improved scraping surface

(5) Vertical outward facing surface (6) Sloped inward facing cone surface

An option may be considered where a threaded system may be used to connect the two units instead of a press fit.

I claim:

1. A double cone shaped windshield Ice scraper, composed of two separate units, one being larger and one being smaller, these units are press fitted together forming a double ended scraper with different sized round scraping surfaces at the ends. The larger end capable of scraping larger areas and the smaller end capable of scraping smaller areas.

2. A double cone shaped windshield ice scraper of claim 1 wherein the units can be separated to allow two separate units, each capable of scraping independently.

3. A double cone shaped windshield ice scraper of claim 1 wherein the new improved scraping surface of both units are composed of a vertical outward facing surface which intersects with an inward facing sloped cone surface.

4. A double cone shaped windshield ice scraper of claim 1 wherein the smaller unit (Pocket Round) scraper has a domed attribute at the top of the handle or (neck) to allow for easier grasp and allow for easier insertion into the (Round 2) scraper.

5. A double cone shaped windshield ice scraper of claim 1 wherein the larger unit (Round 2) is sized to nest in the previously patented “Scrape-A-Round” cone and the smaller unit (Pocket Round) is sized to nest in the (Round 2) cone and the previously patented “Scrape-A-Round” cap will nest in the (Pocket Round) cone thereby the complete wintertime window care system can be packaged together for market.

6. A double cone shaped windshield ice scraper of claim 1 wherein the two units can be connected with a threaded system instead of press fitted.
